(19) United States
(12) Patent Application Publication
(10) Pub. No.: US 2018/0159307 A1
(43) Pub. Date: Jun. 7, 2018

(54) APPARATUS-MULTIPLIER DEVICE

(71) Applicant: ROSI MATERIALE ELETTRICO S.R.L., Parma (PR) (IT)

(72) Inventor: Renato Rosi, Alseno (PC) (IT)

(21) Appl. No.: 15/643,600

(22) Filed: Jul. 7, 2017

(30) Foreign Application Priority Data
Jul. 8, 2016 (IT) 202016000071315

(51) Int. Cl. H02G 3/12; H02G 3/14; H02G 3/18

(52) U.S. Cl. CPC H02G 3/12; H02G 3/18; H02G 3/14

(57) ABSTRACT

The present invention relates to an apparatus-multiplier device (10) particularly, but not exclusively, useful in the field of electrical systems in civil engineering, that can be associated with a box of the flush type (20) for walls, having a closing plate that can be coupled with a plurality of primary apparatuses (21), the apparatus-multiplier device (10) comprising: a plurality of secondary apparatuses (11) electrically connectable in parallel to at least one of the primary apparatuses (11); a support frame (12) that can be fastened to a wall, which comprises at least one housing portion (13) to house the secondary apparatuses (11) and a coupling portion (14) adapted to be coupled with the closing plate in such a way as to leave the primary apparatuses (21) accessible by a user.

The present invention relates to an apparatus-multiplier device particularly, but not exclusively, useful in the field of electrical systems in civil engineering.

For the purposes of the present description, the sockets, the switches and other control devices of an electrical system are generically indicated as apparatuses of the system.

As is well known, nowadays, such apparatuses are embedded in walls at the boxes of the flush type. These boxes of the flush type are embedded in the walls opened towards the exterior, in such a way as to define a space for housing the apparatuses. The boxes of the flush type are, then, closed by means of a closing plate, commonly called apparatus-bearing plate, which can be removably attached to the body of the box by screws or other fastening means. The apparatuses are engaged by snap-fitting in receiving seats obtained on the closing plate, and they are housed in the compartment defined by the box. The apparatuses are connected to the electrical cables of the power supply line of the electrical system, which are inserted into the box of the flush type through pre-fractured walls of the body of the box. Lastly, the installation is generally completed with a finishing plate, which can be fastened on the covering plate by fastening means, e.g. screws, or by clip latching means.

As is well known, boxes of the flush type can be of various sizes, depending on the number of apparatuses they have to contain. In particular, each box of the flush type is intended for the installation of a predetermined number of apparatuses. Therefore, if one desires a higher number of apparatuses to be available at a box of the flush type than the number provided by that box, it is necessary to use so-called apparatus-multiplier devices, e.g. multiple-socket power strips. As is well known, multiple-socket power strips comprise a main body bearing a plurality of electrical sockets, that can be connected to a wall-mounted electrical socket by means of a flexible cable that terminates with an electrical plug. Multiple-socket power strips thus permit to multiply wall-mounted electrical sockets, but they are bulky, they cause disorder and they do not achieve a secure connection to the electrical power supply system, because there is always a risk of accidental disconnection of the plug that connects the main body to the multiplied electrical socket.

The object of the present invention is to overcome the aforementioned drawbacks, and in particular to provide an apparatus-multiplier device that is able to achieve a stable and secure connection with the electrical power supply system, ensuring an orderly configuration with reduced bulk compared to known multiple-socket power strips, and that is, at the same time, simple to install.

This and other objects according to the present invention are achieved by providing an apparatus-multiplier device as set forth in claim 1.

Additional features of the apparatus-multiplier device are described in the dependent claims.

The features and advantages of an apparatus-multiplier device according to the present invention will be more evident from the following exemplifying and non-limiting description, referred to the accompanying schematic drawings, wherein:

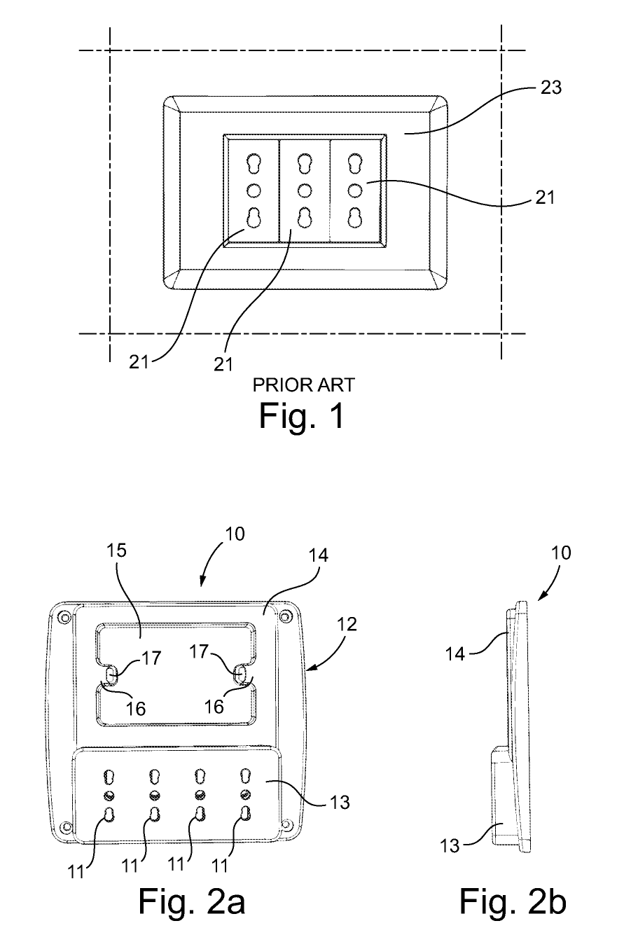

FIG. 1 is a front view of three electrical sockets embedded in a wall according to a known configuration, which also provides for the use of a finishing plate;

FIGS. 2a and 2b are two schematic front and side views, respectively, of a first embodiment of an apparatus-multiplier device according to the present invention;

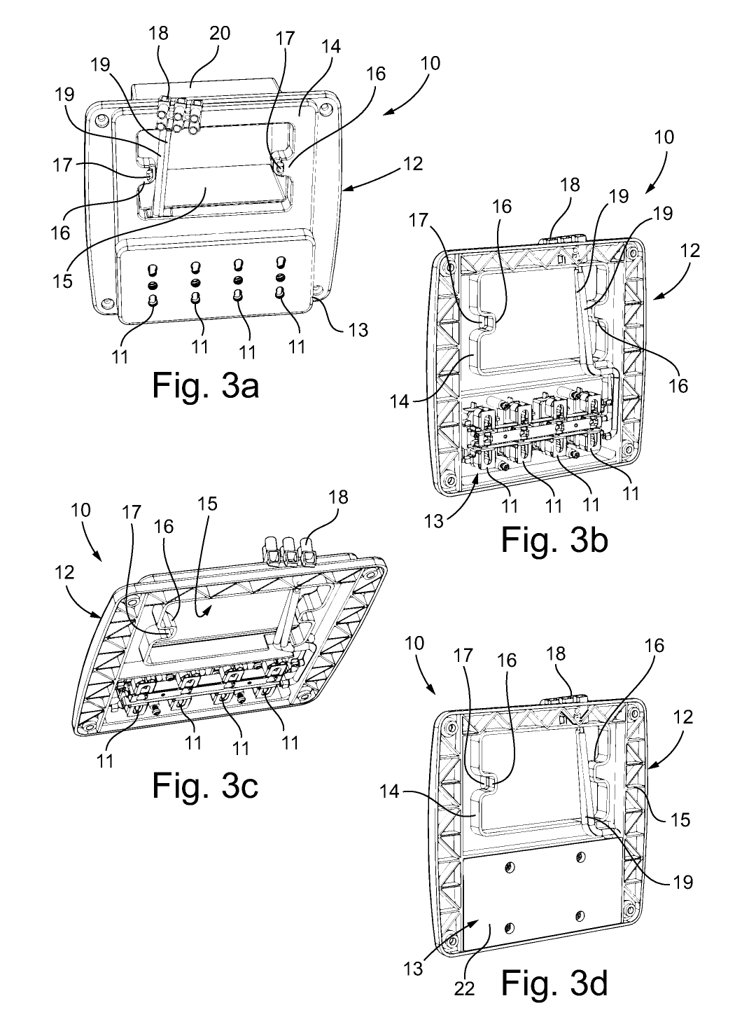

FIG. 3a is a front schematic perspective view of the apparatus-multiplier device of FIGS. 2a and 2b with an exposed terminal block;

FIG. 3b is a first rear schematic perspective view of the apparatus-multiplier device of FIG. 3a;

FIG. 3c is a second rear schematic perspective view of the apparatus-multiplier device of FIG. 3a;

FIG. 3d is a third rear schematic perspective view of the apparatus-multiplier device of FIG. 3a with a rear closing element;

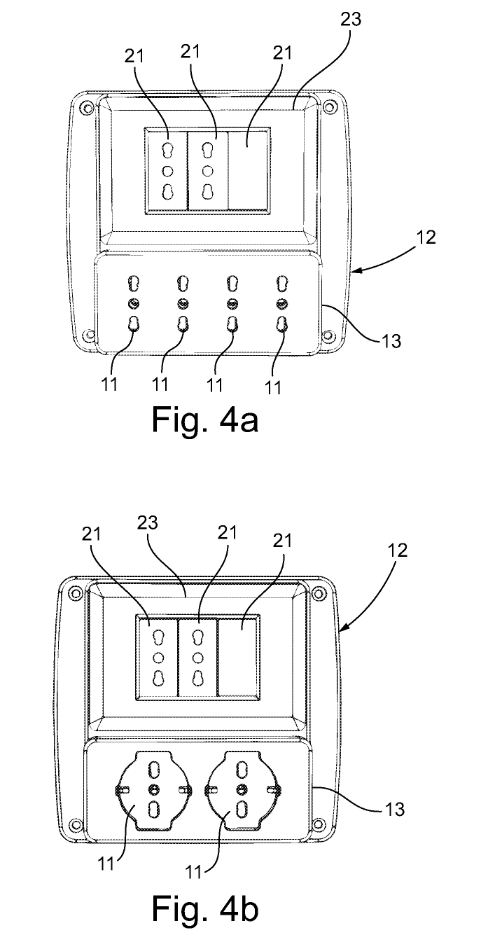

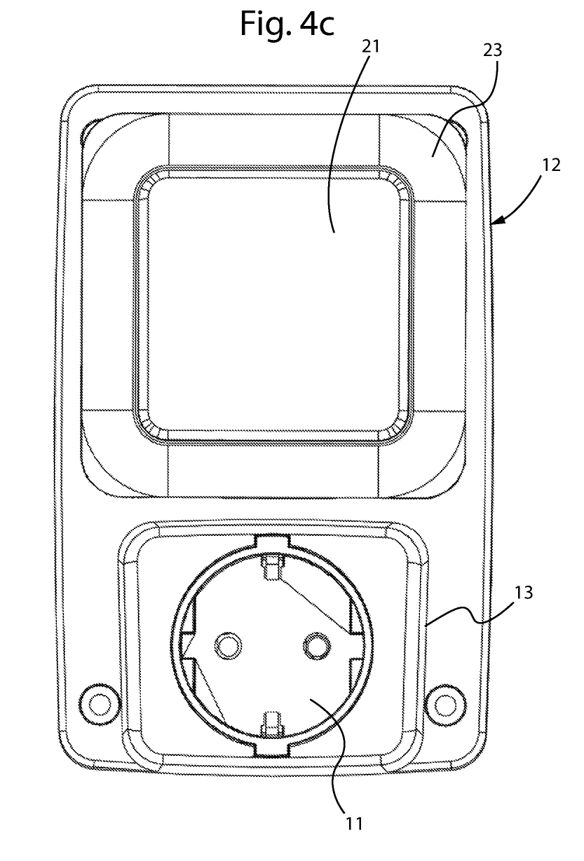

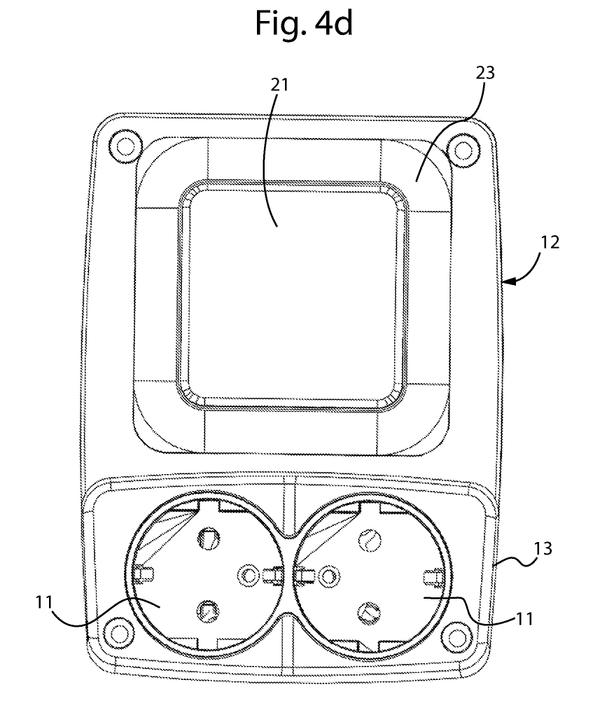

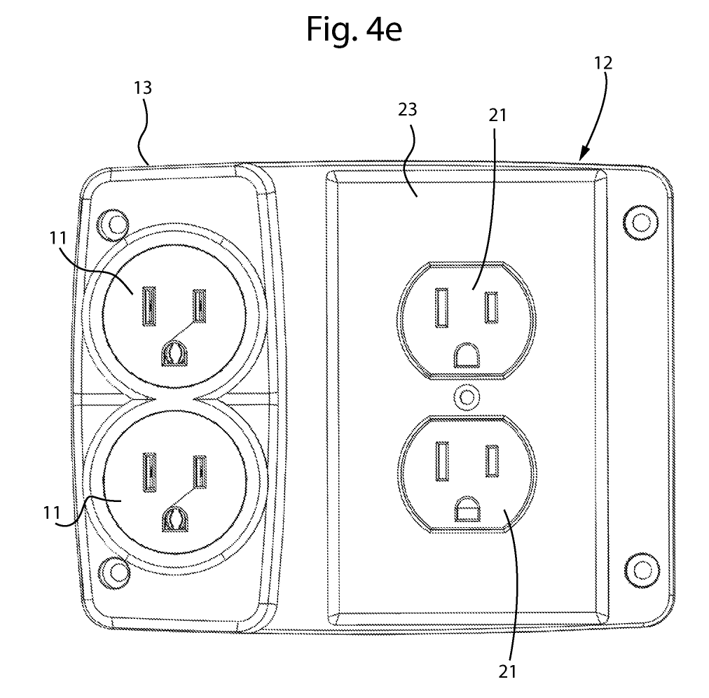

FIG. 4a is a front schematic view of the apparatus-multiplier device of FIG. 2a in a mounting configuration;

FIG. 4b is a front schematic view of a second embodiment of an apparatus-multiplier device according to the present invention in a mounting configuration;

FIG. 4c is a front schematic view of a third embodiment of an apparatus-multiplier device according to the present invention in a mounting configuration;

FIG. 4d is a front schematic view of a fourth embodiment of an apparatus-multiplier device according to the present invention in a mounting configuration;

FIG. 4e is a front schematic view of a fifth embodiment of an apparatus-multiplier device according to the present invention in a mounting configuration;

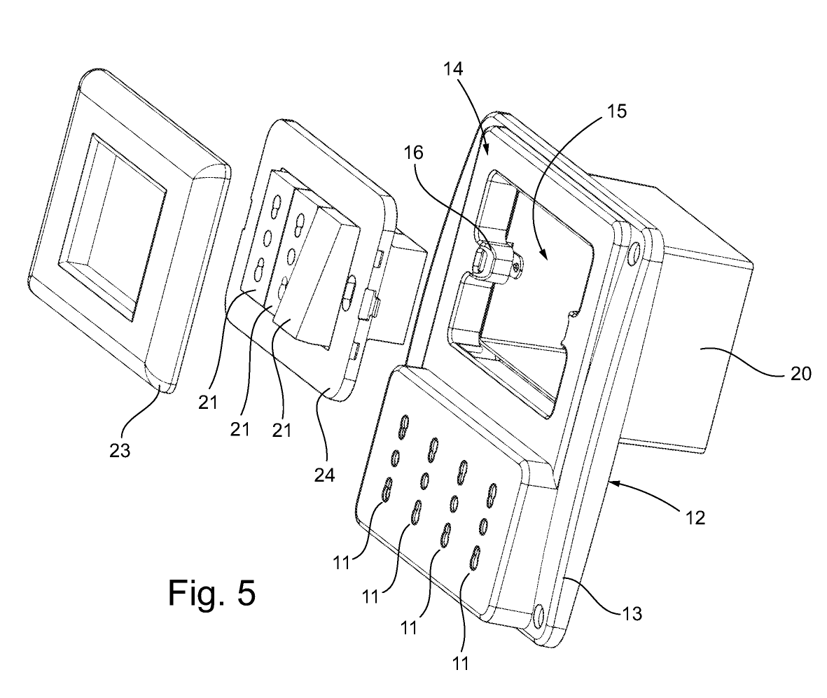

FIG. 5 is a partially exploded schematic perspective view of the assembly of FIG. 4a.

With reference to the figures, an apparatus-multiplier device is shown, indicated in its entirety by the number 10.

Said apparatus-multiplier device 10 can be, in particular, associated with a box of the flush type 20 for walls, provided with a closing plate 24 that can be coupled with a plurality of primary apparatuses 21. The box of the flush type 20 can also be provided with a finishing plate 23 that can be coupled with the closing plate.

In the present description, the term “primary apparatuses” is meant to indicate the apparatuses which are to be installed or have already been installed in the closing plate 24 of a box of the flush type 20, i.e. the apparatuses already provided in the boxes of the flush type of the electrical system.

The apparatus-multiplier device 10 thus comprises a plurality of secondary apparatuses 11 electrically connectable in parallel to at least one of the primary apparatuses 21.

It has to be noted that any combination of apparatuses may be provided, i.e. sockets and switches of various types, both among the primary apparatuses and among the secondary apparatuses.

According to the present invention, the apparatus-multiplier device 10 further comprises a support frame 12 that can be fastened to a wall, which comprises at least one housing portion 13 to house and support the secondary apparatuses 11 and a coupling portion 14 adapted to be coupled with the closing plate 24 of a box of the flush type in such a way as to leave the primary apparatuses 21 accessible by a user. In detail, the support frame 12 can be fastened to a wall by screws or other fastening means.

The coupling portion 14 is then coupled with the closing plate 24, enabling in any case a user to have available the primary apparatuses 21 mounted in respective receiving seats obtained in the closing plate 24 itself. For example, if such primary apparatuses 21 are sockets, the user can reach them to insert respective electrical plugs into the sockets; if at least one of the primary apparatuses 21 is a manual switch, the user can manually operate that switch.

The maximum number of primary apparatuses 21 is set by the dimensions and by the type of the box of the flush type; differently, the maximum number of secondary apparatuses 11 depends on the dimensions of the at least one housing portion 13 of the multiplier device 10.

Preferably, the coupling portion 12 comprises a through opening 15 adapted to make a receiving seat for the closing plate 24.

As in the embodiment shown in the accompanying figures, the support frame 12 can be shaped as a plate element having a window or through opening 15 with complementary shape and dimensions to those of the closing plate 24.

Preferably, the coupling portion 14 comprises two opposite protrusions 16 which project towards the interior of the through opening 15; such opposite protrusions 16 advantageously have through seats 17 adapted to be crossed by fastening elements to fasten the closing plate 24 to the box of the flush type 20. These through seats 17 can, for example, be threaded. Preferably, the at least one housing portion 13 is positioned perimetrically along one side of the through opening 15. More in general, the support frame 12 can comprise a plurality of housing portions 13 arranged around the coupling portion 14 in any position.

Preferably, the secondary apparatuses 11 are electrically connected by means of electrical cables to a terminal block 18 adapted to achieve the connection in parallel to at least one of the primary apparatuses 21.

In the particular embodiment shown in the enclosed figures, the housing portion 13 supports a series of secondary apparatuses 11, such as for example the electrical sockets shown, located in succession one after the other. In this way, the wiring of such secondary apparatuses 11 is simplified, since all the electrical cables employed for the connection of each secondary apparatus can be grouped in shared cables or protection tubes 19, as shown for example in FIGS. 3b and 3c.

Preferably, the housing portion 13 can be closed posteriorly by a rear closing element 22, that can be coupled with the support frame 12 by, for example, fastening means.

The installation of the apparatus-multiplier device 10 according to the present invention takes place as follows with particular reference to a generic box of the flush type 20.

Once such box of the flush type 20 is opened, removing any finishing plate 23 and the closing plate 24 the electrical connections are effected in parallel between the secondary apparatuses 11 and at least one of the primary apparatuses 21. These electrical connections can advantageously be effected by means of the terminal block 18 with which the apparatus-multiplier device 10 is provided.

If the apparatus-multiplier device 10 is not provided with such terminal block 18, the connections are effected in a way that is per se known, connecting the electric cables relating to each secondary apparatus 11 to the terminals that are on the back of the primary apparatuses 21.

Once the electric connections are readied, the support frame 12 is fastened to the wall in such a way that the coupling portion 14, and more in particular the through opening 15, is placed at the opening of the box of the flush type.

At this point, the closing plate 24 of the box of the flush type 20 is applied on the coupling portion 14, more in particular in such a way as to engage it in the receiving seat defined by the through opening 15.

The installation can end with the application of the finishing plate 23, when required, on the closing plate 24.

From the above description, the features of the apparatus-multiplier device subject of the present invention are clear, as well as the relative advantages are clear.

In fact, such device allows to increase the number of apparatuses available at a box of the flush type without causing disorder, whilst assuring the connection of the secondary apparatuses to the power supply line of the electrical system, because such connection is not exposed to external agents, such as water, and to potential intentional or fortuitous tampering.

The apparatus-multiplier device is also small in size, being able to be fastened to a wall and to protrude only by the bulk of the supported secondary apparatuses.

Lastly, it is clear that the apparatus-multiplier device thus conceived is susceptible to many modifications and variations, all within the scope of the invention; furthermore, all details can be replaced by technically equivalent elements. In practice, the materials used, as well as the dimensions, can be of any type according to the technical requirements.

1. Apparatus-multiplier device (10) that can be associated with a box of the flush type (20) for walls, having a closing plate (24) that can be coupled with a plurality of primary apparatuses (21), said apparatus-multiplier device (10) comprising:
a plurality of secondary apparatuses (11) electrically connectable in parallel to at least one of said primary apparatuses (21);
a support frame (12) that can be attached to a wall, which comprises at least one housing portion (13) to house and support said secondary apparatuses (11) and a coupling portion (14) adapted to be coupled with said closing plate (24) in such a way as to leave said primary apparatuses (21) accessible by a user.

2. Apparatus-multiplier device (10) according to claim 1, wherein said mating portion (14) comprises a through opening (15) adapted to make a receiving seat for said closing plate (24).

3. Apparatus-multiplier device (10) according to claim 2, wherein said at least one housing portion (13) is positioned perimetrically along a side of said through opening (15).

4. Apparatus-multiplier device (10) according to claim 1, wherein said mating portion (14) comprises two opposite protrusions (16) which project towards the interior of said through opening, said opposite protrusions (16) having through seats (17) able to be traversed by fastening elements to fasten said closing plate (24) to said box of the flush type (20).

5. Apparatus-multiplier device (10) according to claim 1, wherein said secondary apparatuses (11) are electrically connected by means of electrical cables to a terminal block (18) adapted to achieve said connection in parallel to at least one of said primary apparatuses (11).

6. Apparatus-multiplier device (10) according to claim 1, wherein said at least one housing portion (13) houses and supports a series of secondary apparatuses (11) located in succession one after the other.

7. Apparatus-multiplier device (10) according to claim 1, wherein said support frame (12) comprises a plurality of said housing portions (13) (13) arranged around said coupling portion (14) in any position.
